(19) United States
(12) Patent Application Publication
(10) Pub. No.: US 2015/0095824 A1
(43) Pub. Date: Apr. 2, 2015

(54) METHOD AND APPARATUS FOR PROVIDING USER INTERFACE ACCORDING TO SIZE OF TEMPLATE EDIT FRAME

(71) Applicant: SAMSUNG ELECTRONICS CO., LTD., Suwon-si (KR)

(72) Inventor: Won-seok Song, Seoul (KR)

(73) Assignee: SAMSUNG ELECTRONICS CO., LTD., Suwon-si (KR)

(21) Appl. No.: 14/294,606

(22) Filed: Jun. 3, 2014

(30) Foreign Application Priority Data
Oct. 1, 2013 (KR) 10-2013-0117588

(51) Int. Cl. G06F 3/0484

(52) U.S. Cl. CPC G06F 3/04845; G06F 3/0484
USPC 715/769; 715/771

(57) ABSTRACT

A method and apparatus for providing a user interface according to a size of a template edit frame are provided. The method includes: selecting a template based on a user interface; detecting a subject from an image to fit the selected template to the subject; determining a size of an edit frame of the fitted template based on whether at least a portion of the fitted template strays from a display area; and displaying the fitted template and an edit frame having a size that is determined not to stray from the display area.

### CROSS-REFERENCE TO RELATED APPLICATIONS

This application claims the priority benefit of Korean Patent Application No. 10-2013-0117588 filed on Oct. 1, 2013 in the Korean Intellectual Property Office, the disclosure of which is incorporated herein in its entirety by reference.

### BACKGROUND

1. Field

One or more embodiments of the present disclosure relate to a method and apparatus for providing a user interface according to a size of a template edit frame.

2. Description of the Related Art

Photographing techniques that allow a user to select and synthesize templates, such as stickers, etc., with a captured image or the like have recently become popular.

In general, current techniques allow a user to edit (scale or rotate) a template by providing a square-shaped edit frame that encloses the template.

However, the edit frame may stray from the display screen, and thus it may be difficult to carry out certain functions using the edit frame. For example, the edit frame may be larger than the display screen or the template may be positioned at an edge of the display screen.

Thus, in order to properly use the edit frame, the user must repeatedly move the edit frame into the display screen, perform the desired editing operation, and return the edit frame to its original position.

### SUMMARY

One or more embodiments of the disclosure includes a method and apparatus for providing a user interface according to a size of a template edit frame, by which a determination is made as to whether the template edit frame has strayed from a display area and, based on the determination, the size of the template edit frame is changed into a size that is easily controlled by a user. These embodiments provide added convenience to the user.

Additional aspects will be set forth in part in the description which follows and, in part, will be apparent from the description, or may be learned by practice of the embodiments described.

According to one or more embodiments, a method of providing a user interface according to a size of a template edit frame, includes: selecting a template based on a user interface; detecting a subject from an image to fit the selected template to the subject; determining a size of an edit frame of the fitted template based on whether at least a portion of the fitted template strays from a display area; and displaying the fitted template and an edit frame having a size that is determined not to stray from the display area.

The determining of the size of the edit frame of the fitted template may include: generating a first edit frame corresponding to the fitted template; generating a second edit frame corresponding to the detected subject; and if the first edit frame is in the display area, determining to display the first edit frame, and if at least a portion of the first edit frame is not in the display area, determining to display the second edit frame.

The template edit frame may include an object that receives an input of performing at least one of a deletion, a position change, a size change, an x-axis rotation, a y-axis rotation, and a z-axis rotation of the template.

The determining of the size of the edit frame may include: determining whether the object is in the display area.

The method may further include: editing the template based on the user interface.

The template may be rotated based on a central point of the edit frame having the determined size to be edited.

If an input of dragging the first edit frame is received, the template may be moved regardless of the determined size of the edit frame.

The subject may be a face of a person.

The fitting of the template may include: changing a size of the template based on a size of the subject.

The fitting of the template may include: moving a position of the template based on a position of the subject.

The fitting of the template may include: extracting yaw, pitch, and roll values of the subject; and rotating the selected template by the extracted yaw, pitch, and roll values.

According to one or more embodiments, an apparatus for providing a user interface according to a size of a template edit frame, includes: a template selector that selects a template based on a user interface; a template fitter that detects a subject from an image to fit the selected template to the subject; an edit frame size determiner that determines a size of an edit frame of the fitted template based on whether at least a portion of the fitted template strays from a display area; and a display unit that displays the fitted template and the edit frame having the determined size.

The edit frame size determiner may include: a first frame generator that generates a first edit frame corresponding to the fitted template; and a second frame generator that generates a second edit frame corresponding to the subject. If the first edit frame is in the display area, the first edit frame may be determined to be displayed, and if at least a portion of the first edit frame is not in the display area, the second edit frame may be determined to be displayed.

The template edit frame may include an object that receives an input of performing at least one of a deletion, a position change, a size change, an x-axis rotation, a y-axis rotation, and a z-axis rotation of the template.

The edit frame size determiner may determine whether the object is in the display area to determine a size of an edit frame of the fitted template.

The apparatus may further include: a template editor that edits the template based on user input.

The template editor may rotate the template based on a central point of the edit frame having the determined size when receiving a signal for rotating the template based on user input.

If an input of dragging the first edit frame is received, the template editor may move the template.

According to one or more embodiments, a computer-readable recording medium has recorded thereon a program for embodying the method.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram of an apparatus for providing a user interface according to a size of a template edit frame, according to an embodiment;

FIG. 2 is flowchart of a method of fitting a template, according to an embodiment;

FIG. 3 is a is a diagram illustrating rotation directions of yaw, pitch, and roll of a detected subject according to an embodiment;

FIGS. 4A and 4B are views illustrating a 3-dimensional (3D) rotation of a template according to embodiments;

FIG. 5 is a flowchart of a method of 3-dimentally rotating a template, according to an embodiment;

FIGS. 6A through 6D are views illustrating an operation of 3-dimensionally rotating a template, according to an embodiment;

FIG. 7 is a flowchart of a method of fitting a template to a subject based on subject information, according to an embodiment;

FIG. 8A is a view illustrating an image to which a template will be applied, according to an embodiment;

FIG. 8B is a view illustrating a 2-dimensional (2D) template according to an embodiment;

FIG. 8C is view illustrating a 2D template according to another embodiment;

FIG. 9 is a view illustrating a method of fitting a template, according to an embodiment;

FIG. 10 is a flowchart of a method of providing a user interface according to a size of a template edit frame, according to an embodiment;

FIG. 11 is a schematic view displaying a template edit frame according to an embodiment;

FIG. 12 is a view displaying a template edit frame according to an embodiment;

FIG. 13 is a view illustrating a method of providing a user interface according to a size of a template edit frame, according to an embodiment;

FIG. 14 is a view illustrating a method of providing a user interface according to a size of a template edit frame, according to another embodiment; and

FIG. 15 is a view illustrating a method of providing a user interface according to a size of a template edit frame, according to another embodiment.

### DETAILED DESCRIPTION

Reference will now be made in detail to embodiments, examples of which are illustrated in the accompanying drawings, wherein like reference numerals refer to like elements throughout. In this regard, the embodiments may have different forms and should not be construed as being limited to the descriptions set forth herein. Accordingly, the embodiments are described below by referring to the figures. Expressions such as “at least one of,” when preceding a list of elements, modify the entire list of elements.

It will be understood that, although the terms, ‘first’, ‘second’, etc. may be used herein to describe various elements, these elements should not be limited by these terms. These terms are only used to distinguish one element from another.

Hereinafter, various embodiments will be described in detail with reference to the attached drawings. Like reference numerals in the drawings denote like elements.

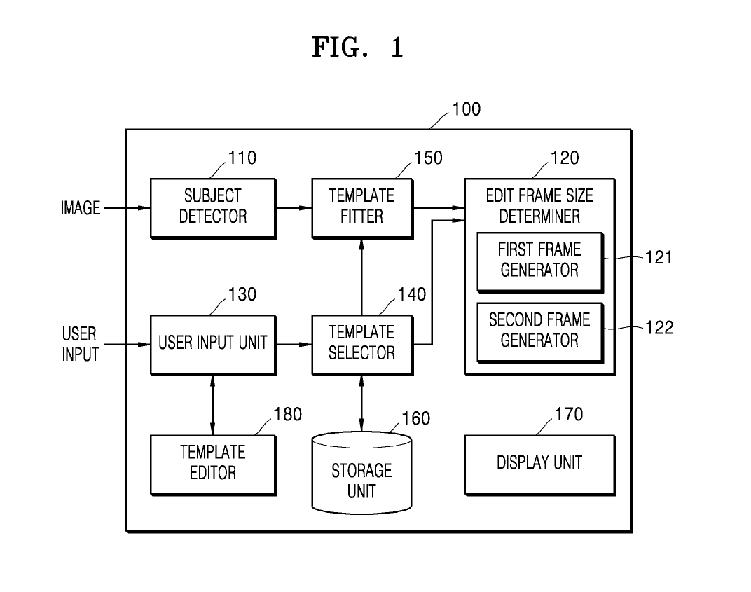

FIG. 1 is a block diagram of an apparatus 100 for providing a user interface according to a size of a template edit frame, according to an embodiment.

The apparatus 100 includes only elements related to the present embodiment. However, the apparatus 100 may further include other general-purpose elements besides the elements of FIG. 1. Also, the apparatus 100 may be a digital camera, a digital camcorder, a smartphone, a laptop computer, or a tablet PC that may process a digital image but is not limited thereto.

Referring to FIG. 1, the apparatus 100 according to the present embodiment includes a subject detector 110, an edit frame size determiner 120, a user input unit 130, a template selector 140, a template fitter 150, a storage unit 160, a display unit 170, and a template editor 180.

The subject detector 110 according to the present embodiment may detect a subject from an input image.

For example, if the detected subject is a face of a person, the subject detector 110 may perform face recognition. Therefore, the subject detector 110 may detect the face based on a color or an edge. Here, methods of performing face recognition are well known, and thus, a detailed description thereof is omitted.

The subject detector 110 may extract subject information including a position, a size, and an angle of the subject from the detected subject.

For example, if the detected subject is a face of a person, the subject detector 110 may extract position information and size information of the detected face. Also, the subject detector 110 may extract angle information of the detected face based on a direction of a line connecting both eyes of the detected face or a line perpendicular to the line. The present invention is not limited thereto, and various methods of extracting face angle information may be used. Here, the extracted angle information may be yaw, pitch, and roll values of the detected subject.

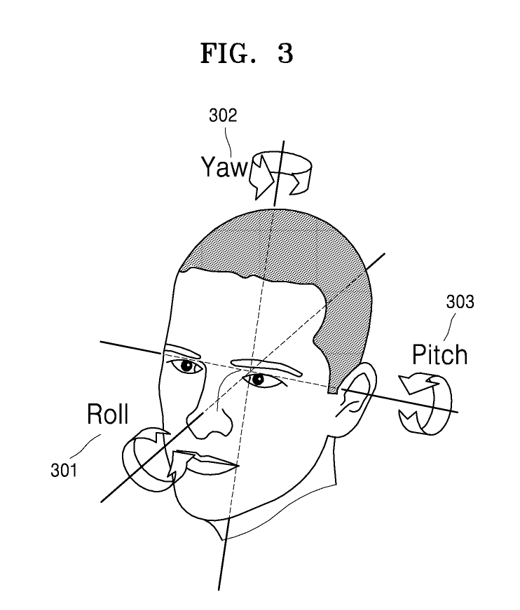

FIG. 3 is a diagram illustrating rotation directions of yaw, pitch, and roll of a detected subject, according to an embodiment.

Referring to FIG. 3, in a rotation of a detected person's face, Z-axis rotation 301 is referred to as roll, X-axis rotation 302 is referred to as yaw, and Y-axis rotation 303 is referred to as pitch.

Referring to FIG. 1 again, the user input unit 130 may include various types of input devices, such as a touch panel, a keypad, buttons, etc., via which a user inputs desired information. For example, one of a plurality of templates stored in the storage unit 160 may be selected or a selected template may be minutely adjusted to fitted to a subject based on user input received by the user input unit 130.

The template selector 140 may select one of the plurality of templates stored in the storage unit 160 based on the user input received by the user input unit 130. Here, a template may include an image that may be synthesized with an image such as a wig, accessories, clothes, makeup, or a sticker.

A template fitter 150 may fit the selected template selected to the detected subject based on the extracted subject information.

For example, the template fitter 150 may 3-dimensionally rotate the template by yaw, pitch, and roll values of the detected subject.

In detail, the template fitter 150 may move a position of the template based on a position of the extracted subject. The template fitter 150 may also change a size of the template based on a size of the extracted subject.

For example, if the template is a wig, and the subject is a face, the template fitter 150 may change a size of the wig according to a size of the detected face. Here, if a face area detected from an image is a first area, an area including a whole wig template is a second area, and an area of the wig template to which a face will be positioned is a third area, a size of the second area may be adjusted at a fixed ratio so that the sizes of the first and third areas are the same. Here, the second area may be an area in which a face will be positioned when making a template and which will be preset.

The template fitter 150 may move the wig having the changed size to a face position. Here, an area (a third area) of a wig image where a face will be positioned matches with a face area (a first area). For example, the template fitter 150 may match a center of the first area with a center of the third area.

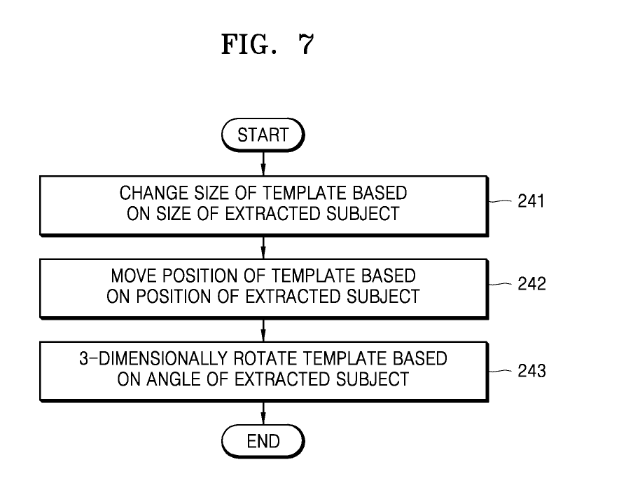

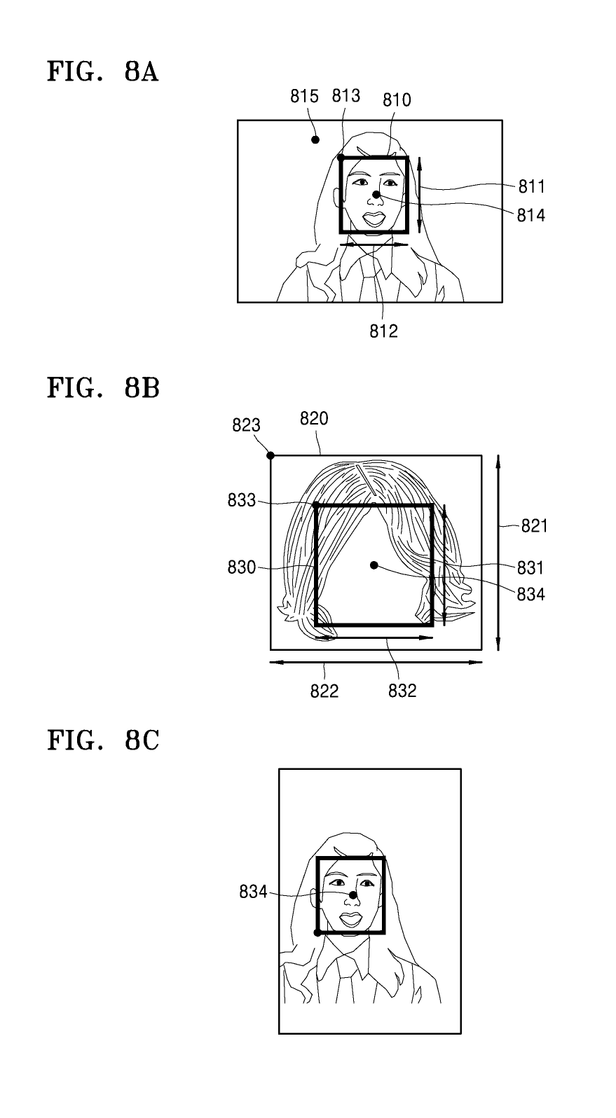

A method of changing a size and a position of a template to fit the template based on subject information will be described in detail with reference to FIGS. 7 and 8.

The template fitter 150 may 3-dimensionally rotate the template on a central axis based on the subject information.

In detail, the template fitter 150 may move the selected template to match a center of the selected template with a center of a rotation axis, 3-dimensionally rotate the moved template on the rotation axis according to an angle of the subject, and return the 3-dimensionally rotated template to an original position. In other words, before rotating the template on the rotation axis, a process of moving the template to the rotation axis may be added to rotate the template on the central axis.

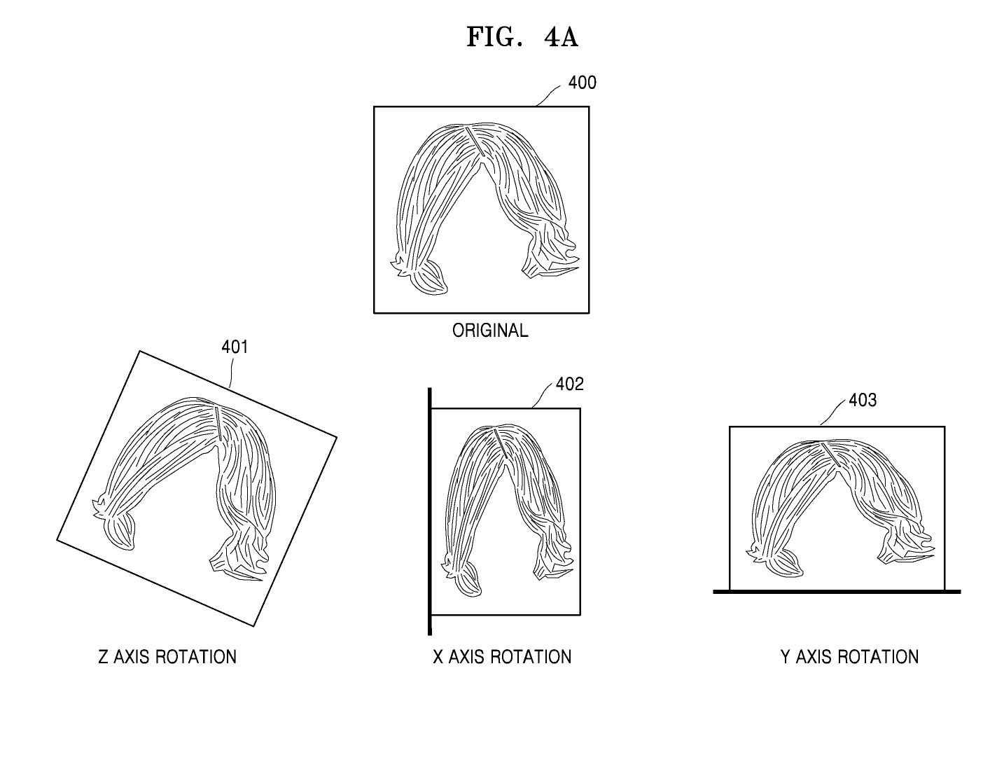

The method of moving the selected template to the rotation axis based on the extracted subject information to 3-dimensionally rotate the template on the central axis will be described in detail with reference to FIGS. 4A through 6D.

The template fitter 150 may display the fitted template on the display unit 170.

Here, the template editor 180 may display a template edit frame with the fitted template on the display unit 170 to edit the fitted template based on user input.

In other words, the template edit frame may display an object that receives an input of performing at least one of a deletion, a position change, a size change, an x-axis rotation, a y-axis rotation, and a z-axis rotation of the template. Therefore, the user may control the object to perform deletion, position change, size change, x-axis rotation, y-axis rotation, or z-axis rotation.

The template editor 180 may also calculate an operation corresponding to the user input in real time and display the calculated operation on the display unit 170. In particular, when the template is 3-dimensionally rotated based on user input, an operation of moving the template to the rotation axis and returning the template to the original position may be internally performed. Therefore, when the template is 3-dimensionally rotated, the position of the template is not changed, and unnatural distortion of a shape of the template may be reduced.

The edit frame size determiner 120 may determine a size of an edit frame of the fitted template based on whether at least a portion of the fitted template has strayed from a display area.

In detail, the edit frame size determiner 120 may include a first frame generator 121 and a second frame generator 122.

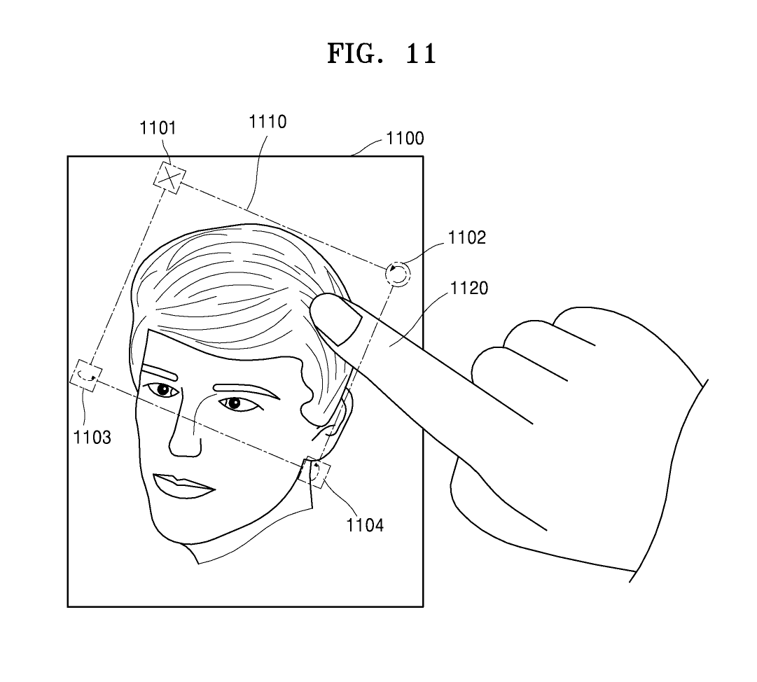

The first frame generator 121 may generate a first edit frame corresponding to the fitted template. Here, the first edit frame refers to an area including the whole fitted template and a square-shaped edit frame enclosing the template to provide an intuitive user interface. Therefore, the edit frame is rotated and moved, and a size of the edit frame is changed according to a rotation, a movement, or a size change of the fitted template. For example, a template edit frame 1110 of FIG. 11 may correspond to the above-described edit frame.

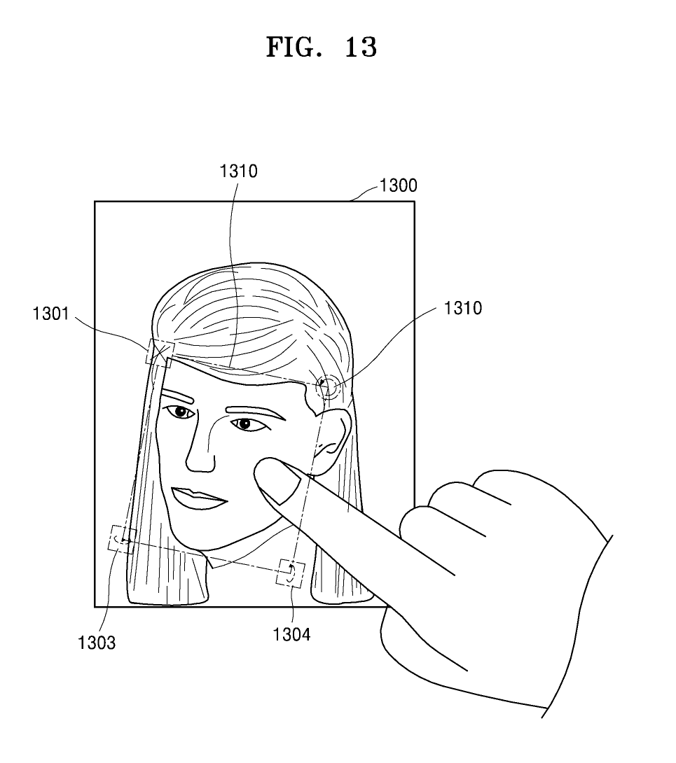

The second frame generator 122 may generate a second edit frame corresponding to a subject area. For example, if the subject area is a face area, the second frame generator 122 may generate an edit frame corresponding to the face area. As another example, an edit frame 1310 of FIG. 13 may be the second edit frame generated by the second frame generator 120. The present disclosure is not limited to this, however, and any element that displays an edit frame in an area that has been reduced to be smaller than the first edit frame if a portion of the first edit frame strays from the display area may be used. Therefore, the second frame generator 122 may generate a frame, which is generated by reducing an area corresponding to an area preset when storing the template or the first edit frame at a fixed ratio, as the second edit frame.

If the first edit frame is fully within the display area, the edit frame size determiner 120 may determine to display the first edit frame. However, if the first edit frame is at least partly outside of the display area, the edit frame size determiner 120 may determine to display the second edit frame.

In particular, if the first edit frame includes an object for editing the template, the edit frame size determiner 120 may determine whether the object falls within the display area and, based on this determination, determine an edit frame size of the fitted template.

The storage unit 160 may be a nonvolatile storage medium that stores digital data, such as a hard disk drive (HDD), a flash memory, or the like. The storage unit 160 stores various types of computer programs that are necessary for the user to use the apparatus 100 as well as information that is personally managed. In particular, the storage unit 160 may store a template that will be selected by the template selector 140 and an image from which a subject will be detected.

The display unit 170 may display an edit frame having a size that is determined to be fully within the display area.

Here, the display unit 170 may include at least one of a liquid crystal display (LCD), a thin film transistor-liquid crystal display (TFT-LCD), an organic light-emitting diode (OLED) display, a flexible display, a 3D display, and an electrophoretic display. Also, the display unit 170 may be provided in a touch screen form.

In particular, if the display unit 170 is provided in a touch screen form, the user may minutely control the edit frame displayed on the display unit 170 through a touch input to fit the template in a desired form to the subject.

The methods described herein may be performed by one processor or a plurality of processors. A processor may be implemented as an array of a plurality of logic gates or as a combination of a general-purpose microprocessor and a memory that stores a program executable in the general-purpose microprocessor. The processor may also be implemented as one or more other types of hardware.

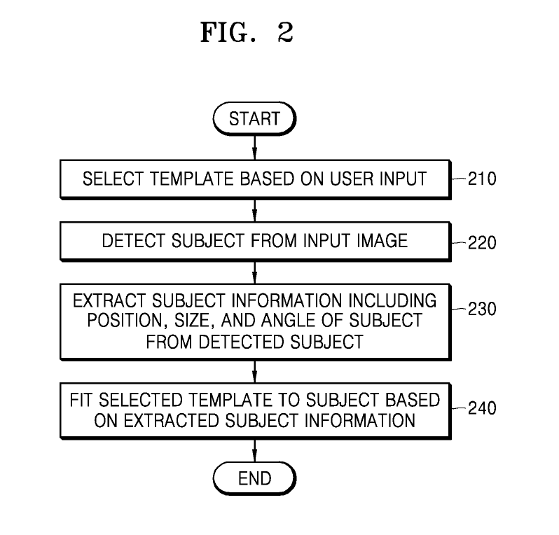

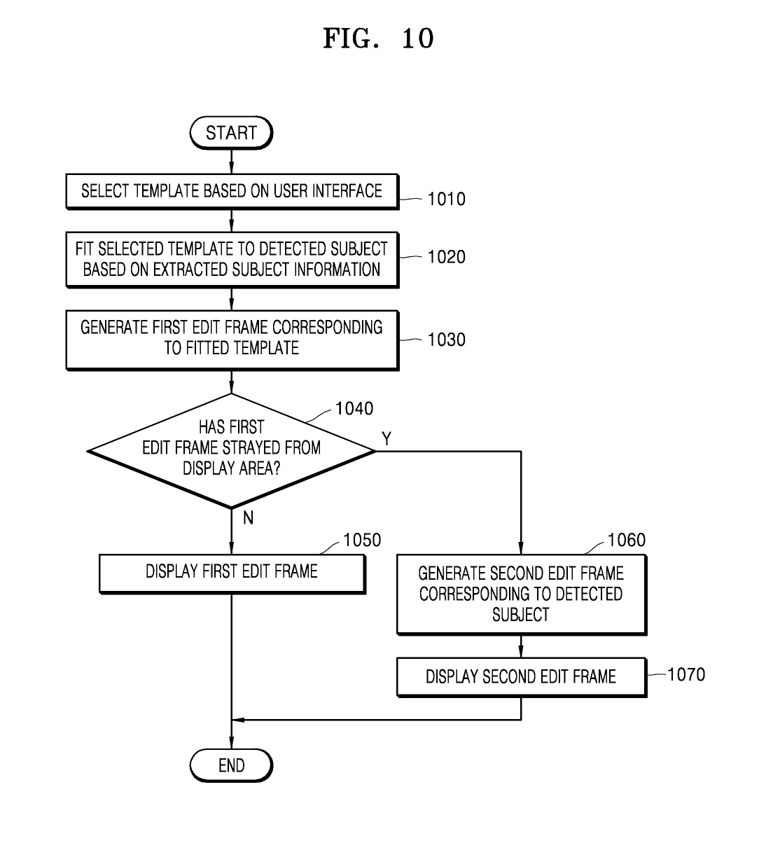

An embodiment of a method of fitting a template will be described in detail with reference to FIGS. 2 through 9. An embodiment of a method of providing a user interface according to a size of a template edit frame will be described in detail with reference to FIGS. 10 through 15.

FIG. 2 is a flowchart of a method of fitting a template, according to an embodiment.

In operation 210, the template selector 140 selects a template based on user input. Here, an image that will be synthesized with the template may be first displayed for the user to select the template. The template selector 140 may also display a 2-dimensional (2D) template stored in the storage unit 160 on a screen, which the template selector may select based on user input.

In operation 220, the subject detector 110 detects a subject from an input image. For example, if the detected subject is a face of a person, the subject detector 110 may perform face recognition. Therefore, the subject detector 110 may detect the face based on a color or an edge.

In operation 230, the subject detector 110 may extract subject information including a position, a size, and an angle of the subject from the detected subject.

For example, if the detected subject is the face of the person, the subject detector 110 may extract position information and size information of the detected face based on the color or the edge.

In operation 240, the subject detector 110 fits the selected template to the detected subject based on the extracted subject information.

FIGS. 4A and 4B are views illustrating a 3-dimensional (3D) rotation of a template according to an embodiment.

Referring to FIG. 4A, reference numeral 400 denotes a 2D template image having a wig shape. In general, a stored template has a shape that faces forward.

Reference numeral 401 denotes a Z-axis rotation of a template, reference numeral 402 denotes an X-axis rotation of the template, and reference numeral 403 denotes a Y-axis rotation of the template.

In other words, a 3D rotation method according to an embodiment may be defined as illustrated with reference numerals 401, 402, and 403.

Also, a 3-dimensionally rotated image, as shown in FIG. 4B, may be acquired through a combination of basic rotations as described above.

Image rotation techniques currently used in devices such as digital cameras provides only the z-axis rotation 401. This is because a central rotation point of a Z-axis rotation is set, and rotation is performed based on the central rotation point. Thus, Z-axis rotation is widely used and easily applied.

However, subjects often do not face forward in captured images, and since only a front view is taken when taking a picture, using only a Z-axis rotation is often not sufficient to rotate a template so as to fit the template to the subject.

Therefore, according to an embodiment, a method and apparatus for performing a 3D rotation calculation of a 2D image and for synthesizing a rotated template with an image fit to a subject is provided.

As shown with reference numeral 510 of FIG. 4B, the X- and Y-axes rotations are performed based on a rotation axis like reference numerals 402 and 403 of FIG. 4A. Unlike with a Z-axis rotation, the position and a shape of an image that has been rotated may be distorted. In other words, if a rotation of a template is performed, controlling the position of the template may be difficult. To solve this problem, however, the apparatus 100 may move a template to a rotation axis, 3-dimensionally rotate the template, and return the template to an original position. In other words, as shown with reference numeral 520 of FIG. 4B, an image where a template has been 3-dimensionally rotated based on a central axis may be generated.

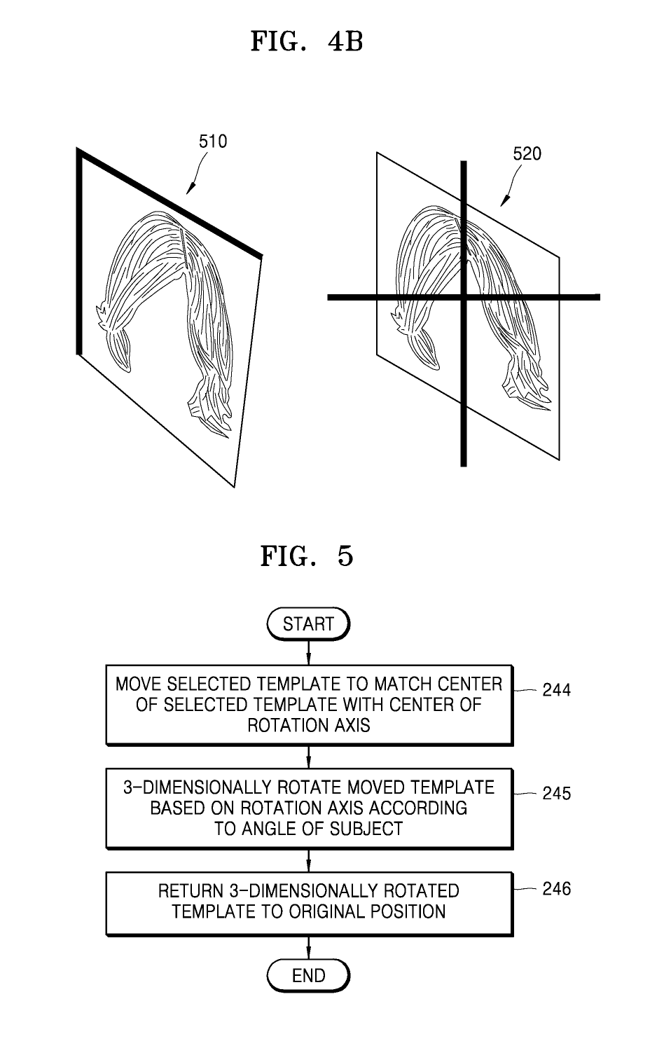

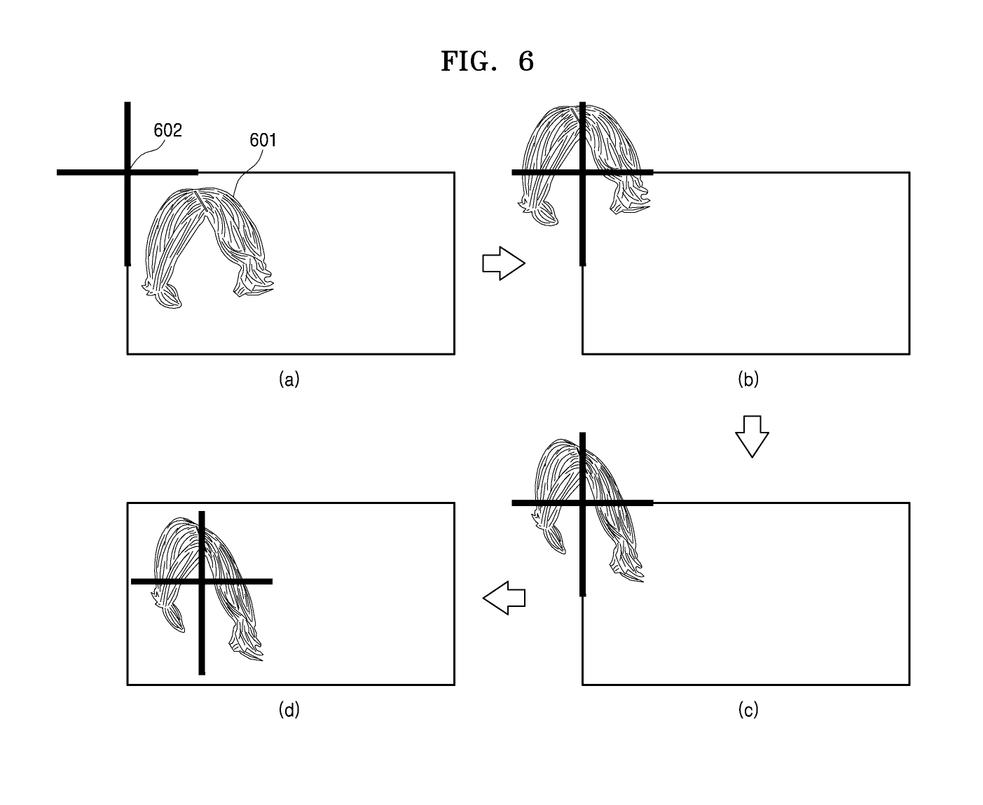

FIG. 5 is a flowchart of a method of 3-dimensionally rotating a template based on a central axis, according to an embodiment. FIGS. 6A through 6D are views illustrating an operation of 3-dimensionally rotating a template, according to an embodiment.

Referring to FIGS. 5 through 6D, in operation 244, the template fitter 150 moves a template to match a center of the template with a center of a rotation axis. For example, the template fitter 150 may move the template to match the center of the template with intersection points (0, 0, 0) of rotation axes X, Y, and Z to 3-dimensionally rotate the template. In other words, a template 601 shown in FIG. 6A may be moved to a center 602 of a rotation axis, as shown in FIG. 6B.

In operation 245, the template fitter 150 3-dimensionally rotates the moved template based on the rotation axis according to an angle of a subject. Here, since the center of the template is moved to match with the rotation axis, the template may be rotated based on a central axis. In other words, as shown in FIG. 6C, the template may be 3-dimensionally rotated based on the rotation axis.

In operation 246, the template fitter 150 returns the 3-dimensionally rotated template to an original position. Therefore, as shown in FIG. 6D, a transformation, such as a rotation of the template from a position thereof based on the central axis, may be performed.

As described above, the template is 3-dimensionally rotated based on the central axis. Therefore, although a 2D template is 3-dimensionally rotated, a position of the template is not changed according to rotation, and thus it is easy to control the position of the template. Also, unnatural distortion of a shape of the 2D template resulting from a 3D rotation may be reduced.

An image transformation as described above may be calculated through a matrix operation. A matrix used for performing a 3D transformation according to an embodiment will now be described.

$$\begin{matrix}{R}_{x} ( θ ) = [ \begin{matrix}1 & 0 & 0 \\ 0 & cos θ & - sin θ \\ 0 & sin θ & cos θ\end{matrix} ] \\ {R}_{y} ( θ ) = [ \begin{matrix}cos θ & 0 & sin θ \\ 0 & 0 & 0 \\ - sin θ & 0 & cos θ\end{matrix} ] \\ {R}_{z} ( θ ) = [ \begin{matrix}cos θ & - sin θ & 0 \\ sin θ & cos θ & 0 \\ 0 & 0 & 1\end{matrix} ] & ( 1 ) \\ [ \begin{matrix}1 & 0 & {t}_{x} \\ 0 & 1 & {t}_{y} \\ 0 & 0 & 1\end{matrix} ] & ( 2 )\end{matrix}$$

The matrix of Equation 1 may be used for an operation of moving a template to a rotation axis and an operation of returning the template to an original position, and the matrix of Equation 2 may be used for an operation of 3-dimensionally rotating the template on the rotation axis. A method of simply rotating or moving an image by using the matrix is well known, and thus, a detailed description thereof is omitted.

FIG. 7 is a flowchart of a method of fitting a template to a subject based on subject information, according to an embodiment.

Referring to FIG. 7, in operation 241, the template fitter 150 changes the size of the template based on a size of an extracted subject.

For example, FIG. 8A illustrates an image to which a template will be applied, according to an embodiment. FIG. 8B illustrates a 2D template according to an embodiment.

Referring to FIGS. 8A and 8B, for convenience of description, a subject may be a face, and the template may be a wig. However, the present disclosure is not limited thereto.

A height 811 of a face area 810 is defined as FD_height, a width 812 of the face area 810 is defined as FD_width, and x, y coordinates of a point 813 indicating a position of the face area 810 are respectively defined as FD_x and FD_y.

A height 821 of a template 820 having a wig image shown in FIG. 8B is defined as Template_height, a width 822 of the template 820 is defined as Template_width, and x, y coordinates of a point 823 indicating a position of the template 820 are respectively defined as Template_x and Template_y.

The template 820 shown in FIG. 8B may include an area 830 in which a detected face will be positioned. Here, the area 830 may be an area that is necessary for aesthetically fitting the template 820 to a subject and that may be experientially or experimentally set by a designer.

Here, a height 831 of the area 830 is defined as WS_height, a width 832 of the area 830 is defined as WS_width, and x, y coordinates of a point 833 indicating a position of the area 830, in which the face will be positioned when a template is displayed in an image, are respectively defined as WS_x and WS_y.

Thus, a size adjustment ratio of a template may be acquired according to Equation 3 below.

Ratio_width=FD_width/WS_width

Ratio_height=FD_height/WS_height (3)

The template fitter 150 may change the size of the template according to Equation 4 below.

Template_height=Template_height*Ratio_height

Template_width=Template_width*Ratio_width (4)

Referring to FIG. 7 again, in operation 242, the template fitter 150 moves the position of the template 820 based on a position of the extracted subject.

For example, referring to FIGS. 8A and 8B again, the template fitter 150 may resize and move the rotated template 820 to match the template 820 with the face area 810.

When the template 820 is moved to be fitted, the position of the template 820 is moved to a particular position to match the area 830 of the template 820, in which the face will be positioned, with the face area 810. However, since the size of the template 820 is different from that of the face area 810, the simple movement of the position of the template 820 to a position of the face area 810 does not match the face area 810 with the area 830.

Therefore, if the template 820 is moved from the position of the face area 810 to a position 815 that is scaled by the size of the template 820 and a ratio of the area 830 resized in operation 241 or the face area 810, an image where a template has been appropriately fit may be acquired.

As another example, the template fitter 150 may move the template 820 to match a central position 814 of the face area 810 with a central position 834 of the area 830 in which the face of the template 820 will be positioned.

Here, the central position 814 of the face area 810 is used to move the template 820 because a center of a face is unrelated to a rotation angle, and thus the template is effectively positioned. For example, as shown in FIG. 8C, although the image on the display (including the face) is rotated 90°, the center 834 of the face is the same. Therefore, after the template 820 is transferred to match the center location 834 of template and the center location 814 of face, there is an advantage in that only the three-dimensional rotation of the template for fitting to the face needs to be carried out. Also, there is another advantage that a ratio calculation is not needed for fitting the template to the face area.

Here, central coordinates of a template that will be moved to match with the face area 810 may be acquired by Equation 5.

Scaled_Centsr_{—}WS_{—}x=(WS_{—}x+(WS_width/2))*Ratio_width

Scaled_Centsr_{—}WS_{—}y=(WS_{—}y+(WS_height/2))*Ratio_height (5)

In other words, in Equation 5, the center 834 of the template 820 may be determined as a center of the area 830 in which the face will be positioned.

The center 834 of the template may match with the center 814 of the face according to Equation 6 below to fit the template 820 to the face area 810.

FD_{—}x+FD_width/2=Scaled_Center_{—}WS_{—}x

FD_{—}y+FD_height/2=Scaled_Center_{—}WS_{—}y (6)

Referring to FIG. 7 again, in operation 243, the template fitter 150 3-dimensionally rotates the template on a central axis based on subject information. Operation 243 has been described with reference to FIG. 5, and thus, a detailed description thereof is omitted.

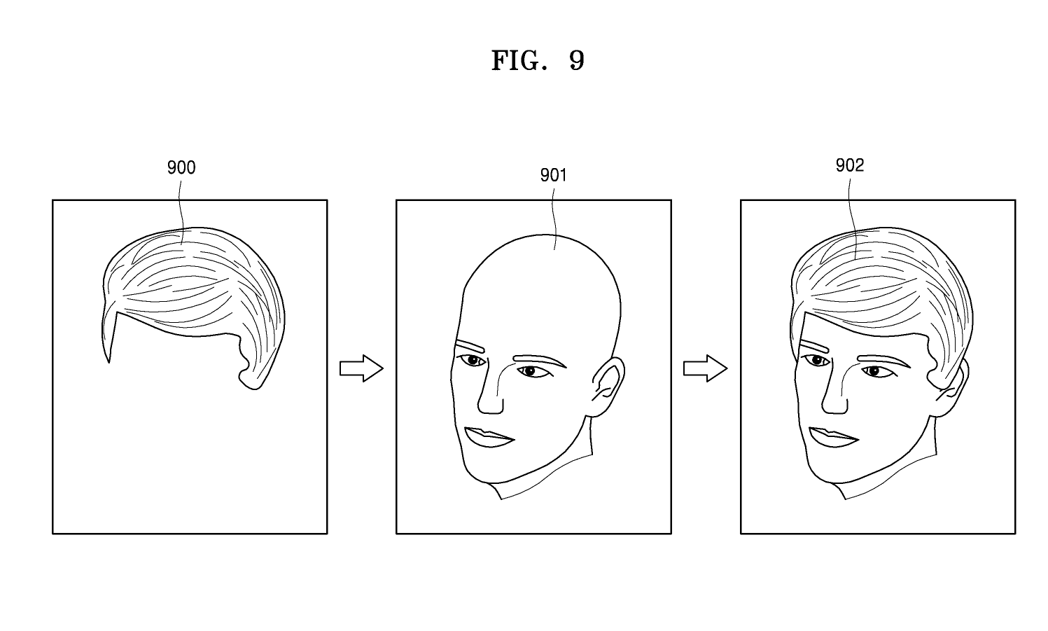

FIG. 9 is a view illustrating a method of fitting a template, according to an embodiment.

Referring to FIG. 9, if the template selector 140 selects a wig template 900 based on user input, as described above with reference to FIGS. 2 through 8B, the subject detector 110 may detect a face as a subject 901 from an image and fit the wig template 900 to the subject 901 based on detected subject information as shown with reference numeral 902.

A method of providing a user interface according to a size of a template edit frame, according to an embodiment, will now be described in detail with reference to FIGS. 10 through 15.

FIG. 10 is a flowchart of a method of providing a user interface according to a size of a template edit frame, according to an embodiment.

Referring to FIG. 10, the method includes operations that are processed by the apparatus 100 of FIG. 1 in a time series. Therefore, although the above descriptions of the apparatus 100 of FIG. 100 are omitted below, the descriptions may be applied to the method of FIG. 10.

In operation 1010, the template selector 140 selects one of a plurality of templates stored in the storage unit 160 of the apparatus 100 based on user input received by the user input unit 130. Here, a template may include an image that may be synthesized with an image such as a wig, accessories, clothes, makeup, a sticker, etc.

In operation 1020, the template fitter 150 fits the selected template to a detected subject based on extracted subject information.

For example, the template fitter 150 may move the position of the template based on the position of the extracted subject. The template fitter 150 may change the size of the template based on the size of the extracted subject.

For example, if the template is a wig, and the subject is a face, the template fitter 150 may change the size of the wig according to the size of the detected face.

For example, if the face area detected from an image is a first area, an area including a whole wig template is a second area, and an area of the wig template to which a face will be positioned is a third area, the size of the second area may be adjusted at a fixed ratio so that sizes of the first and third areas are the same. The second area may be preset when the template is produced.

In operation 1030, the first frame generator 121 generates a first edit frame corresponding to the fitted template. For example, the template edit frame 1110 of FIG. 11 may be the first edit frame.

FIG. 11 is a schematic view displaying the template edit frame 1110 according to an embodiment.

Referring to FIG. 11, the apparatus 100 may display the first edit frame 1110 corresponding to a fitted template. Here, the first edit frame 1110 may refer to an area that includes a whole area of the fitted template or a square-shaped edit frame that encloses a template to provide an intuitive user interface. The template edit frame 1110 includes one or more objects that can receive a user input for deleting or rotating the template. In FIG. 11, the edit frame 1110 includes a deletion object 1101, a z-axis rotation object 1102, an x-axis rotation object 1103, and a y-axis rotation 1104 object of the fitted template. A user does not have to select one of the objects in order to move (drag and drop) an area in which a template edit frame is positioned. Additionally, a user may select a corner of the template edit frame to change its size.

Therefore, according to an embodiment, a first edit frame may be generated and displayed to provide an intuitive interface of a template edit frame to the user, as shown in FIG. 11.

Referring to FIG. 10 again, in operation 1040, the edit frame size determiner 120 determines whether the first edit frame has strayed from—i.e., is no longer fully within—the display area.

For example, the template may stray from the display area due to rotation or size enlargement of a long-haired wig. For example, since the first edit frame is proportional to the size of the template area, a portion of the first edit frame may stray from the display area.

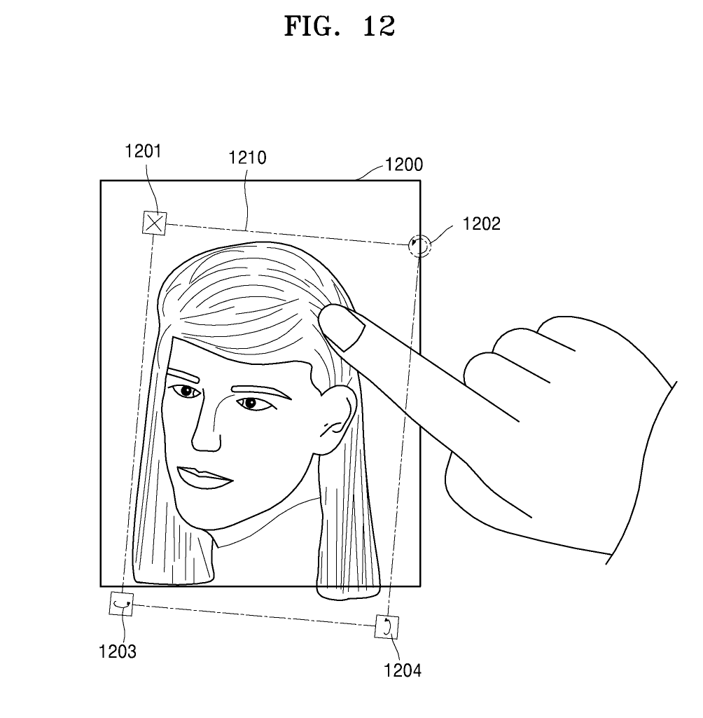

For example, FIG. 12 is a view displaying a template edit frame according to an embodiment.

As shown in FIG. 12, a template like a long-haired wig may occupy a large area of a screen, and once the template is fitted to a subject according to a position and an angle of the subject's face, at least a portion of the template may overlap the edge of the display area 1200.

In this case, as shown in FIG. 12, an x-axis rotation object 1203 and a y-axis rotation object 1204 of a first edit frame 1210 may stray from the display area 1200. Therefore, the whole portion of the first edit frame 1210 may be moved into the display area 1200 so that the user can properly edit the template edit frame 1210.

In other words, the edit frame size determiner 120 determines whether at least one of objects 1201, 1202, 1203, and 1204 included in the template edit frame 1210 has strayed from the display area 1200.

If the first edit frame is in the display area, as shown in FIG. 11, the method proceeds to operation 1050 to display the first edit frame in the display area and edit the template based on user input.

However, if the first edit frame is not in the display area, as shown in FIG. 12 (or at least one object receiving an edit command of the user strays from the display area as shown in FIG. 12), the method proceeds to operation 1060 to allow the second frame generator 122 to generate a second edit frame corresponding to a subject area.

FIG. 13 illustrates a method of providing an interface if a template edit frame strays from a display user area, according to an embodiment.

Referring to FIG. 13, if a subject area is a face area, the second frame generator 122 may generate a second edit frame 1310 corresponding to the face area. Here, an area corresponding to the face area may refer to the area 830 of the template of FIG. 8A in which the face will be positioned as described with reference to FIGS. 8A and 8B, rather than a face area that is detected from an image. In other words, an area of a template in which a preset face will be positioned may be determined as the second edit frame 1310. Here, when a position of the template is moved, a size of the template is changed, and the template is rotated, a position, a size, and a rotation angle of the second edit frame 1310 may also be changed to correspond to the template. Therefore, the second frame generator 122 may generate a second edit frame that is reduced so that it can be fully included in the display area. A method of calculating the area of the template in which the face will be positioned has been described with reference to FIGS. 8A and 8B, and thus, a detailed description thereof is omitted.

However, the position of the subject area has been calculated in a template fitting operation, and the second frame generator 122 does not perform a calculation with respect to the subject area. Therefore, the second edit frame generator 122 may display the second edit frame in the subject area of the template acquired in the template fitting operation.

However, if the template editor 180 receives a signal of a user selecting an additional template, or if the size change, the position movement, or the rotation of the template is performed based on user input, then the template fitting operation is omitted. Therefore, an area of the template in which a subject will be positioned is continuously calculated as described with reference to FIGS. 8A, 8B, and 8C.

In other words, the subject area corresponding to the changed size, position, and rotation angle of the template may be repeatedly generated and displayed as the second edit frame to provide a user interface through which the user may continuously and intuitively edit the template.

In operation 1070, the second edit frame 1310 is displayed. In detail, the template editor 180 may display the template edit frame with the fitted template on the display unit 170 to additionally edit the fitted template based on user input.

The template editor 180 may also calculate an operation corresponding to the user input in real time and display the operation on the display unit 170. In particular, according to an embodiment, when a template is 3-dimensionally rotated based on user input, an operation of moving the template to a rotation axis and moving the template to an original position may be internally performed to display an operation of rotating the template in real time without distortion.

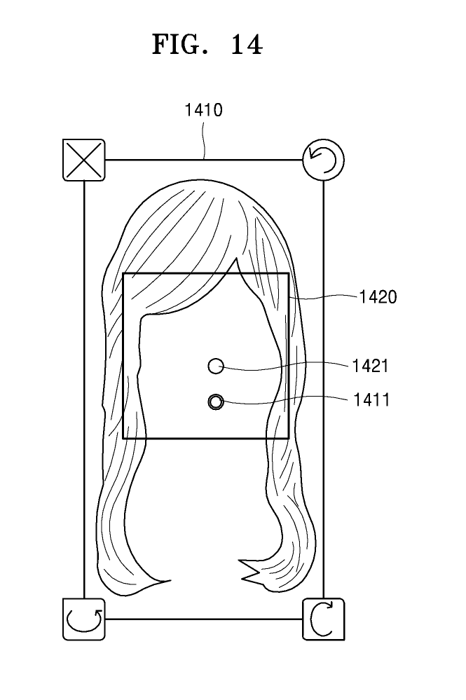

FIG. 14 is a view illustrating a method of providing a user interface according to a size of a template edit frame, according to another embodiment.

Referring to FIG. 14, a central point 1411 of a first edit frame 1410 and a central point 1421 of a second edit frame 1420 are illustrated. In the present embodiment, since ratios of the first edit frame 1410 and the second edit frame 1420 are directly proportional to each other, the central point 1411 of the first edit frame 1410 and the central point 1421 of the second edit frame 1420 do not match with each other, as shown in FIG. 14.

When receiving a signal for rotating a template based on user input, the template editor 180 may rotate the template based on a central point of a frame that is determined to be displayed. In other words, the template editor 180 may rotate the template based on an area of one of the first edit frame 1410 and the second edit frame 1420 that is displayed, to edit the template according to a user intention. Also, an intuitive user interface may be provided to the user.

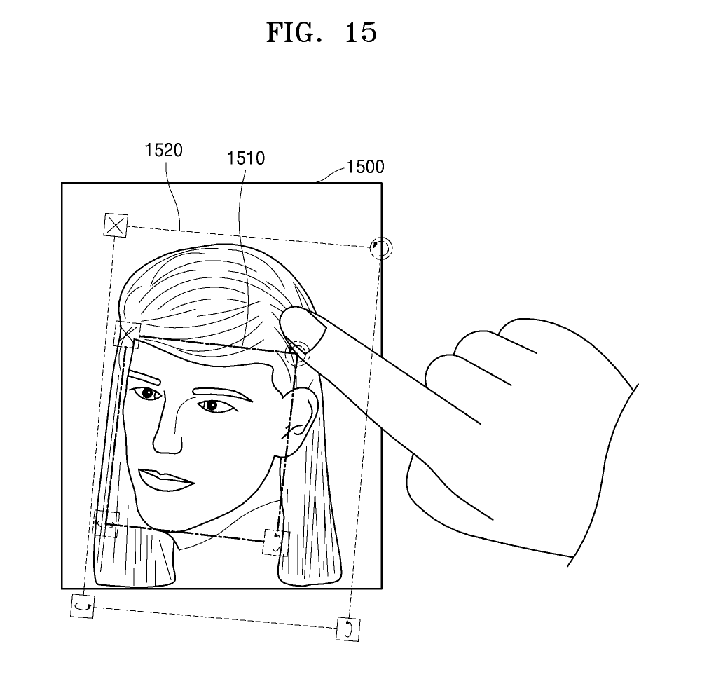

FIG. 15 is a view illustrating a method of providing a user interface according to a size of a template edit frame, according to another embodiment.

Referring to FIG. 15, a first edit frame 1520 strays from a display area 1500, and thus only a second edit frame 1510 is displayed. However, if the second edit frame 1510 is displayed, the second edit frame 1510 may have an area that is smaller than a template area, as shown in FIG. 15. Therefore, although a user selects a template to intuitively move the template, the template may stray from a second edit frame that is displayed, and thus a template edit command may not be received.

Therefore, even in this case, to provide an intuitive user interface to the user, the template editor 180 may perform a template edit operation in a first edit frame (that is not actually displayed on a display screen) according to a command for editing the template, regardless of a size of an edit frame determined by the edit frame size determiner 120.

For example, as shown in FIG. 15, if an input of dragging the first edit frame 1520 is received, the template editor 180 may move the template on a screen on which only the second edit frame 1510 is displayed.

As described above, according to the one or more of the above embodiments, a method of providing a user interface according to a size of a template edit frame may determine whether the template edit frame has strayed from a display area and change a size of the template edit frame into a size that is easily controlled by a user, according to the determination result, to provide user convenience.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the disclosure, reference has been made to the embodiments illustrated in the drawings, and specific language has been used to describe these embodiments. However, no limitation of the scope of the disclosure is intended by this specific language, and the disclosure should be construed to encompass all embodiments that would normally occur to one of ordinary skill in the art. The terminology used herein is for the purpose of describing the particular embodiments and is not intended to be limiting of exemplary embodiments. In the description of the embodiments, certain detailed explanations of related art are omitted when it is deemed that they may unnecessarily obscure the essence of the disclosure.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the disclosure pertains may easily implement functional programs, codes, and code segments for making and using the embodiments.

The embodiments may be described in terms of functional block components and various processing steps. Such functional blocks may be realized by any number of hardware and/or software components configured to perform the specified functions. For example, the embodiments may employ various integrated circuit components, e.g., memory elements, processing elements, logic elements, look-up tables, and the like, which may carry out a variety of functions under the control of one or more microprocessors or other control devices. Similarly, where the elements are implemented using software programming or software elements, the embodiments may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the embodiments may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the disclosure and does not pose a limitation on the scope of the disclosure unless otherwise claimed. Numerous modifications and adaptations will be readily apparent to those of ordinary skill in this art without departing from the spirit and scope of the disclosure as defined by the following claims. Therefore, the scope of the disclosure is defined not by the detailed description but by the following claims, and all differences within the scope will be construed as being included in the disclosure.

No item or component is essential to the practice of the embodiments unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the embodiments (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

Operations of methods described herein may be performed in any appropriate order. The scope of this disclosure is not limited by the following claims, it is not limited by the examples or the exemplary terms. It will be understood by those of ordinary skill in the art that various modifications, combinations, and changes in form and details may be made according to design conditions and factors therein without departing from the spirit and scope as defined by the following claims or equivalents thereof.

What is claimed is:

1. A method of providing a user interface according to a size of a template edit frame, the method comprising:
selecting a template based on a user interface;
detecting a subject from an image to fit the selected template to the subject;
determining a size of an edit frame of the fitted template based on whether at least a portion of the fitted template strays from a display area; and
displaying the fitted template and an edit frame having a size that is determined not to stray from the display area.

2. The method of claim 1, wherein the determining of the size of the edit frame of the fitted template comprises:
generating a first edit frame corresponding to the fitted template;
generating a second edit frame corresponding to the detected subject; and
if the first edit frame is in the display area, determining to display the first edit frame, and if at least a portion of the first edit frame is not in the display area, determining to display the second edit frame.

3. The method of claim 1, wherein the template edit frame comprises an object that receives an input of performing at least one of a deletion, a position change, a size change, an x-axis rotation, a y-axis rotation, and a z-axis rotation of the template.

4. The method of claim 3, wherein the determining of the size of the edit frame comprises: determining whether the object is in the display area.

5. The method of claim 2, further comprising:
editing the template based on the user interface.

6. The method of claim 5, wherein the template is rotated based on a central point of the edit frame having the determined size to be edited.

7. The method of claim 5, wherein if an input of dragging the first edit frame is received, the template is moved regardless of the determined size of the edit frame.

8. The method of claim 1, wherein the subject is a face of a person.

9. The method of claim 1, wherein the fitting of the template comprises: changing a size of the template based on a size of the subject.

10. The method of claim 1, wherein the fitting of the template comprises: moving a position of the template based on a position of the subject.

11. The method of claim 1, wherein the fitting of the template comprises:
extracting yaw, pitch, and roll values of the subject; and
rotating the selected template by the extracted yaw, pitch, and roll values.

12. An apparatus for providing a user interface according to a size of a template edit frame, the apparatus comprising:
a template selector that selects a template based on a user interface;
a template fitter that detects a subject from an image to fit the selected template to the subject;
an edit frame size determiner which determines a size of an edit frame of the fitted template based on that at least a portion of the fitted template strays from a display area; and
a display unit that displays the fitted template and the edit frame having the determined size.

13. The apparatus of claim 12, wherein the edit frame size determiner comprises:
a first frame generator that generates a first edit frame corresponding to the fitted template; and
a second frame generator that generates a second edit frame corresponding to the subject,
wherein if the first edit frame is in the display area, the first edit frame is determined to be displayed, and if at least a portion of the first edit frame is not in the display area, the second edit frame is determined to be displayed.

14. The apparatus of claim 12, wherein the template edit frame comprises an object that receives an input of performing at least one of a deletion, a position change, a size change, an x-axis rotation, a y-axis rotation, and a z-axis rotation of the template.

15. The apparatus of claim 14, wherein the edit frame size determiner determines whether the object is in the display area to determine a size of an edit frame of the fitted template.

16. The apparatus of claim 13, further comprising:
a template editor that edits the template based on user input.

17. The apparatus of claim 16, wherein the template editor rotates the template based on a central point of the edit frame having the determined size when receiving a signal for rotating the template based on user input.

18. The apparatus of claim 16, wherein if an input of dragging the first edit frame is received, the template editor moves the template.

19. The apparatus of claim 12, wherein the subject is a face of a person.

20. A computer-readable recording medium having recorded thereon a program for embodying the method of claim 1.
